(19) United States
(12) Patent Application Publication
(10) Pub. No.: US 2020/0328715 A1
(43) Pub. Date: Oct. 15, 2020

(54) PWM Streaming Serial Interface to Simultaneously Control Multiple BLDC Motors

(71) Applicant: TEXAS INSTRUMENTS INCORPORATED, Dallas, TX (US)

(72) Inventors: Luis Eduardo Ossa, Plano, TX (US); Krushal Shah, Dallas, TX (US); Mayank Garg, Murphy, TX (US); Hao Wang, Shenzhen (CN); Haozhi Liu, Shenzhen (CN)

(21) Appl. No.: 16/843,962

(22) Filed: Apr. 9, 2020

Related U.S. Application Data
(60) Provisional application No. 62/831,328, filed on Apr. 9, 2019.

(51) Int. Cl. H02P 27/08; H02P 1/26; H02P 25/03

(52) U.S. Cl. CPC H02P 27/085; H02P 2209/09; H02P 25/03; H02P 1/26

(57) ABSTRACT

A system for driving one or more motors includes: a controller having an instruction output; one or more motor drivers, each of the motor drivers are coupled to the instruction output of the controller and each of the motor drivers having a unique address; and wherein each motor driver is only operable to receive instruction from the controller when its unique address is provided by the controller at the instruction output.

### CROSS-REFERENCE TO RELATED APPLICATION

This application claims the benefit to co-owned U.S. Provisional Patent Application No. 62/831,328, filed on Apr. 9, 2019 (Attorney Docket No. TI-90986 PS); which is hereby incorporated herein by reference in its entirety.

### TECHNICAL FIELD

This relates to motor drivers. More particularly, this relates to the use of a serial interface to control motor drivers to control multiple motors.

### BACKGROUND

Electric motors are used in many applications. For example, three motors are used to control a gimbal for a camera. Multiple motors are used to control a drone and to control robots. There may be multiple motors used in a safety application due to the desire to have redundancy. Using multiple motors in a single application may result in the need for multiple motor drivers (such as the motor drivers DRV-8320H and DRV-8313 fabricated and provided by Texas Instruments Incorporated) and multiple wires connecting each motor driver to a processor so as to provide the necessary communications between the processor and each motor driver. For example, in a system with “N” motors, it may require 3*N to 4*N communication connections between the processor and the “N” motors. In addition, multiple wires are needed to drive each motor by each motor driver. Using this many wires may require too much space within the system, and it requires a large number of connections to the controllers for each motor.

### SUMMARY

In accordance with at least one example of the disclosure, a system for driving one or more motors includes: a controller having an instruction output; one or more motor drivers, each of the motor drivers are coupled to the instruction output of the controller and each of the motor drivers having a unique address; and wherein each motor driver is only operable to receive instruction from the controller when its unique address is provided by the controller at the instruction output. Each motor driver is coupled to a motor and only drives one motor. Preferably, the instruction output of the controller is a serial bus, and the controller is a microcontroller, microprocessor, digital signal processor or field programmable gate array. In another example embodiment, the system is included in a camera gimbal, drone, robot or an automotive safety system, and motor is a three-phase motor (such as a BLDC motor).

Another example embodiment is a three-phase motor system that includes: a controller; a plurality of motor drivers, each having a distinct address, an input and a motor driver output; a serial bus connecting the controller to each of the plurality of motor drivers; a plurality of motors, each coupled to a motor driver; and wherein each motor driver is operable to receive instructions from the controller only when the distinct address of the motor driver precedes the instructions on the serial bus. Preferably, the controller is a microcontroller, microprocessor, digital signal processor or field programmable gate array, and the three-phase motor system is used in a camera gimbal, drone, robot or an automotive safety system. In another embodiment, the serial bus only includes a clocking connection and an instruction connection, or it only includes a clocking connection, an instruction connection and a feedback connection.

Another example embodiment includes a plurality of motor drivers each for driving a motor based on commands provided to each motor driver by a controller, wherein each motor is coupled to the controller by a serial bus having a clock wire and an instruction wire and each motor only acts upon instructions that are preceded by a unique address for the motor driver. Preferably, each motor is a three-phase motor (such as a BLDC motor).

### BRIEF DESCRIPTION OF THE DRAWINGS

For a detailed description of various examples, reference will now be made to the accompanying drawings in which:

FIG. 1 is a block diagram showing a controller and motor drivers of a first example embodiment;

FIG. 2 is a block diagram showing an implementation of the controller, motor drivers and motors for another example embodiment; and

FIG. 3 is a timing diagram showing signals of an example embodiment.

FIG. 4 is a timing diagram showing signals of an example embodiment.

### DETAILED DESCRIPTION

Disclosed herein is a motor drive system that includes a controller (such as a microcontroller (“MCU”), microprocessor, digital signal processor (“DSP”), field programmable gate array (“FPGA”), signal processor or any other type of processor with a serial interface), one or more motor driver(s) and one or more motor(s) (such as a brushless DC motor (“BLDC”), permanent magnet synchronous motor (“PMSM”), variable AC drive or any 3-phase brushless motor). In different embodiments, the motor driver is part of an integrated circuit, multi-die module (“MDM”), multi-chip module (“MCM”), system on a chip (“SoC”), or other commercial circuit or device. In alternative embodiments, a controller may be implemented on the same semiconductor die as one or more motor drivers or it can be a stand-alone device on a circuit board, MDM or MCM.

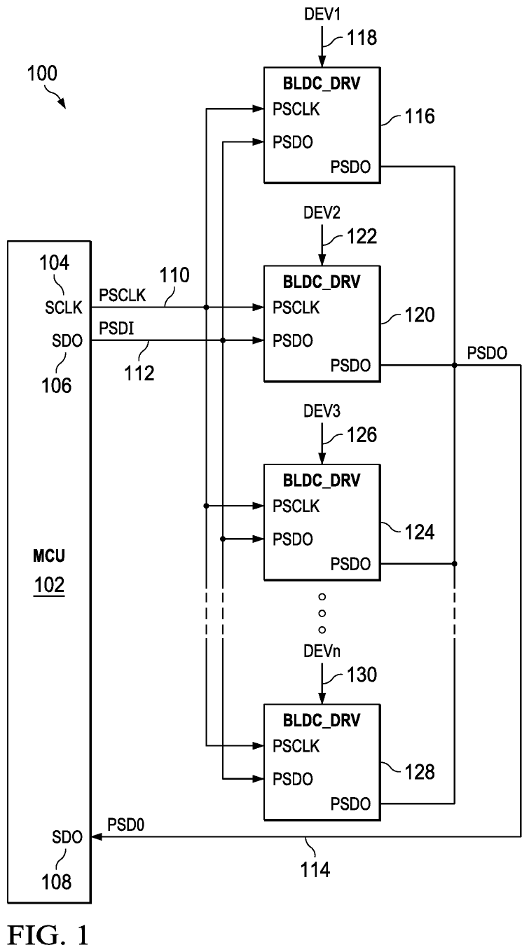

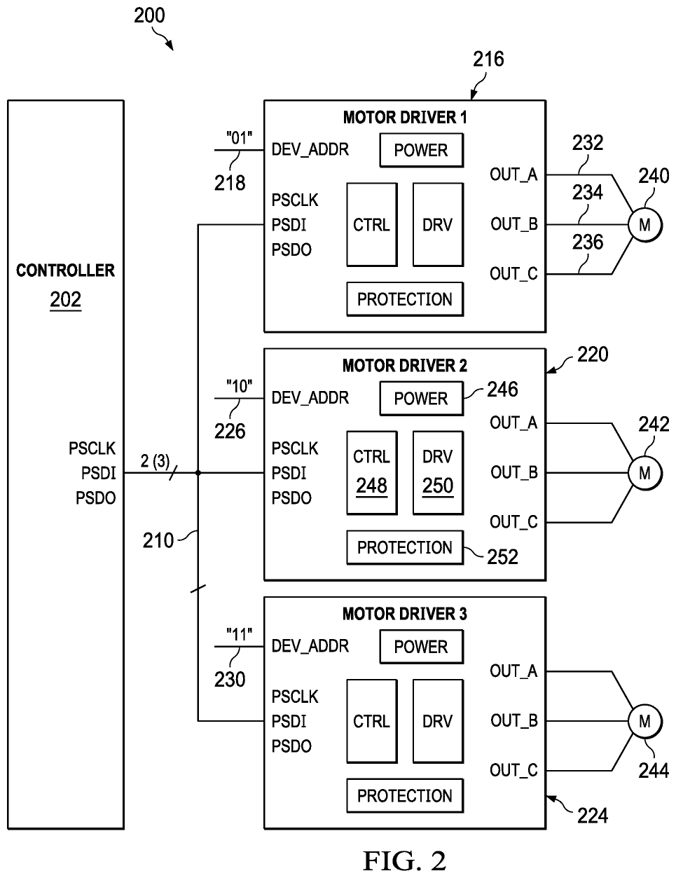

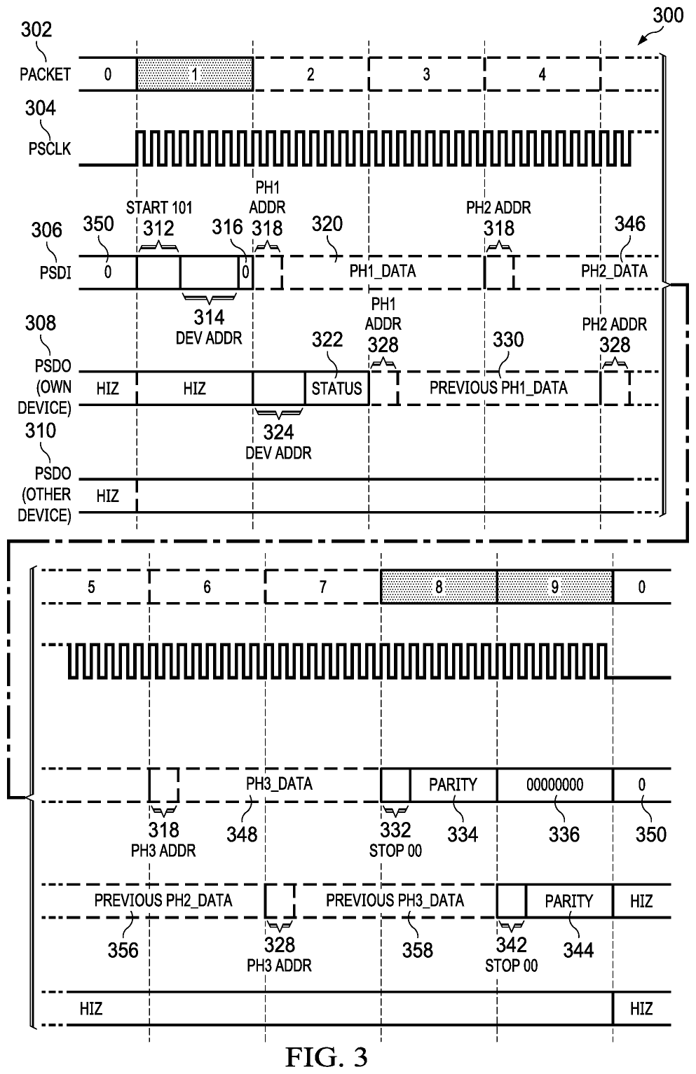

Referring to the example embodiment of FIG. 1, motor drive system 100 includes MCU 102 connected to one or more motor drivers (shown as drivers 116, 120, 124 and 128). As is shown in FIG. 2, the motor drivers are each connected to separate motors. MCU 102 is connected to each motor driver by at least two connections (PSCLK 110 and PSDI 112). A third connection (PSDO 114) may also be used to provide a communication path from the motor drivers back to MCU 102. In this embodiment, PSCLK 110 connection provides a clocking signal (shown in FIG. 3 as PSCLK signal 304) from the MCU 102 to each of the motor drivers. In addition, the PSDI 112 connection is provided to each motor driver and will selectively (discussed in more detail below) provide data/instructions (shown as PSDI signal 308 in FIG. 3) to one (or, possibly, more) motor driver. Optionally, a PSDO 114 connection between the motor drivers and MCU 102 can be provided. The PSDO 114 signal provides confirmation from the addressed motor driver to MCU 102 that the PSDI 112 signal was received, and as described with reference to PSDO signal 308 in FIG. 3, and that the received signal did not contain an error.

Each motor driver 116, 120, 124 and 130 is separately addressable by its assigned address. The assigned address is provided by device address input 118, 122, 126 and 130, respectively. The assigned address may be hard-wired for each device or it may be programmed into the device prior to operation. In one example embodiment, if there are “n” motor drivers (as shown in FIG. 1) then the address will be 2ⁿ⁻¹ bits long with the address of all zeros not used (a two-bit address would be used if there are two motor drivers because an address of “0” is not preferred). Referring to the example embodiment of FIG. 2, since there are three motor drivers the addresses for these motor drivers would be “01”, “10” and “11” and the address of “00” would not be assigned.

With reference to FIGS. 1 and 3, if the device address 118 given to motor driver 116 is “001” and instructions are to be provided to motor driver 116, the portion of PSDI signal that relates to the motor driver address (portion 314 of the PSDI signal 306 of FIG. 3) will be “001”. If the feedback signal PSDO 308 is utilized, portion 324 of PSDO signal 308 would also be “001” so as to confirm this address. Based on the length of the instruction to be provided, one or more of portions 320, 346 and 348 of PSDI signal 306 (FIG. 3) will be provided to all motor drivers but only the addressed motor driver (in this example, motor driver 116) will act on these instructions. If the PSDO signal 308 is utilized, motor driver 116 will respond to MCU 102 by sending device status and present or previous instructions back to MCU 102 in one or more of portions 330, 356 and 358 of PSDO signal 308. The same number of instructions/data portions of signal PSDI 306 will be included (if used) in PSDO signal 308. The instruction/data portions of PSDI 306 and PSDO 308 can be anywhere between 10 and 14 bits long. Portions 320, 346 and 348 of PSDI signal 306 and portions 330, 356 and 358 of PSDO signal 308 are shown as including 14 bits, each, in FIG. 3.

Referring to the example embodiment of FIG. 2, in the motor controller system 200 controller 202 is connected to each motor driver (motor drivers 216, 220 and 224) by bus 210 (preferably, a serial bus such as for a SPI interface or an I2C interface). Bus 210 preferably includes connections to each motor driver for a PSCLK signal 304 and a PSDI signal 306. In addition, bus 210 may include connections for PSDO signal 308 and PSDO signal 310 (used for motor drivers that were not addressed). If connection 114 is provided, both PSDO signal 308 and PSDO signal 310 would be communicated on that conductor. In the bus of FIG. 2, PSDO signal 308 and 310 would be communicated over the same bus.

Each motor driver is shown to be connected to a motor. In alternative embodiments, more or less motor drivers and/or motors can be used. Specifically, motor driver 216 is connected to motor 240 by three connections (232, 234 and 236). Connections 232, 234 and 236 provide the driver signals (preferably a 3-phase power signal) to motor 240. A different number and type of connections can be provided between motor driver 216 and motor 240 depending on the type of motor that is used. Similarly, motor driver 220 is connected to motor 242 and motor driver 224 is connected to motor 244.

Each motor driver may include circuitry relating to the specific addressing of each motor driver (shown as inputs 218, 226 and 230). This specific addressing may be programmed from another device, by connecting certain components to inputs 218, 226 and 230, or provided as specific circuitry (such as programming a value into an internal memory). In addition, each motor driver includes the following functional circuitry blocks: power 246; control 248; driver 250 and protection 252. Power block 246 may include voltage regulators to supply regulated power to other circuitry in the motor driver. In some examples, power block 246 includes a charge pump (to provide the proper gate bias voltage to high-side FETs (such as NMOS FETs) and low-side FETs. Control block 248 may provide a control interface that includes the generation of pulse width modulation (“PWM”) signals for a DC-AC converter (such as a half-bridge inverter), a power-up sequence, a programmable serial interface (“PSI”), device configuration for varying motor sizes and applications, motor current sense-amplifiers and other control functions. In some examples control block 248 may be implemented in hardware or as software running on a processor (or processor-based controller). Protection block 252 provides, in some example embodiments, protection and monitoring functions for under-voltage, over-voltage, over-current and/or over-temperature conditions for the drivers (such as a half-bridge driver) and the motor. Driver block 250 includes, in some example embodiments, FETs (such as NMOS or PMOS transistors) arranged in a half-bridge (or full bridge) configuration that support various PWM control modes. In some example embodiments, each of the three half-bridge inverters drives a phase of a three-phase motor (such as a BLDC).

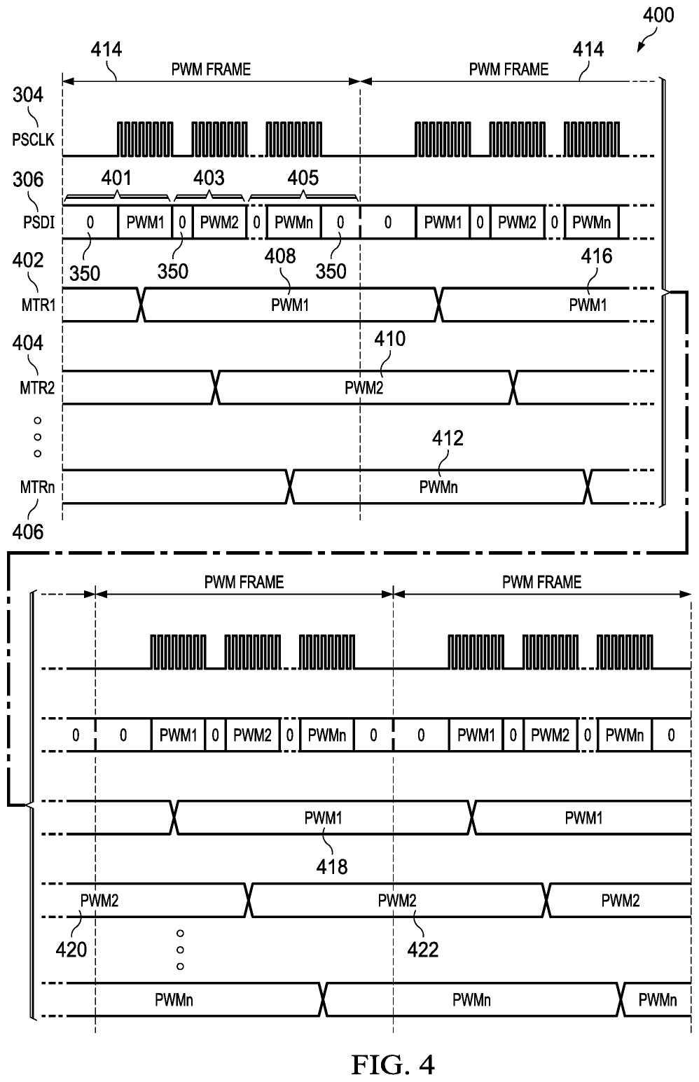

Referring to the example embodiment of FIG. 3 in conjunction with the example embodiment of FIG. 2, packet count 302 are shown in timing diagram 300 and it identifies the count of packets of information that are provided at a particular time period. The period designated as “0” for packet count 302 is the start/end of a PWM frame (shown in more detail in FIG. 4). In some example embodiments, the value for the PSDI signal 306 will be “0” (reference number 350) for packet count “0”. Timing diagram also includes PSCLK signal 30, PSDI signal 306 and PSDO signals 308 and 310 (one or both may or may not be used in an example embodiment). While FIG. 3 shows nine separate packets, there may be more or less packets communicated (such as, for example, 2, 5 or 7 packets). In some example embodiments, each packet of information contains 8 bits. Data/instructions sent in a signal frame (such as data/instructions 320) may contain between 10 to 22 bits (preferably, 10 to 14 bits).

In some example embodiments, each data/instruction packet corresponds to the duty cycle (10 to 22 bit resolution (preferably, 10 to 14 bits) of the PWM signal that drives a power MOSFET half-bridge, and each half-bridge drives a phase of a three-phase BLDC motor. The PWM signals are provided sequentially at certain frequencies and are used to control the operation of the motor. The PWM frequency and PWM data resolution to control the motor operation preferably is large enough for proper motor operation. Each of the three-phase motors in the system operate at the same PWM frequency, and the PWM data/instructions for several motors are, preferably, sent every PWM period. In some example embodiments, the frequency of PSCLK of the PSI serial interface is, preferably, high enough to support several motors.

PSCLK signal 30 is a clocking signal and may have a higher or lower frequency depending on the example embodiment. In one example embodiment, PSDI signal 306 starts with a start key 312 in packet count 1. This alerts the motor drivers that a packet stream will be coming. In the example embodiment of FIG. 3, start key 312 is “101”. Device address 314 is sent, next. Device address 314 identifies which motor driver the processor is communicating with. For example, in the example embodiment of FIG. 2, if the commands/instructions 320, 346 and 348 are intended for motor driver 220, device address 314 would be “10”. Alternatively, if device address 314 was “11” then controller 202 would be providing instructions/commands 320, 346 and 348 to motor driver 224. While the instructions/commands are only acted on by the addressed motor driver, the non-addressed motor drivers still drive its motor, in some example embodiments.

Still referring to packet count 1 of PSDI signal 306, transition bit 316 (shown as a “0” in FIG. 3 but can be any set value of a set number of bits) is placed between device address 314 and the start of the instruction/command packets. Starting at packet count 2, each instruction/command packet starts with a phase address (such as phase addresses 318) and is followed with an instruction/command (such as instruction/command 320, 346 and 348). Phase address 318 is preferably two bits (in other example embodiments it may be 1-bit or 3-bits). The first instance of phase address 318 will be “01” (representing phase “A” of the instructions/commands). The next instance of the phase address (between instruction/commands 320 and 346) will be “10” (representing phase “B”) and the next will be “11” (representing phase “C”). However, in other example embodiments, the phase addresses do not have to be in order and there can be any number (including zero) of phase addresses provided for an instruction/command set 300. While three phase address are shown, the number of phase addresses will correspond to the number of instruction/command phases that are sent from controller 202. There may be 0, 1, 2, 3 or more phases (preferably, three phases of instructions/commands as is show in FIG. 3) of instructions/commands that are sent. The number of bits used for a phase of instructions/commands corresponds to the PWM duty cycle for that phase. In some example embodiments, each phase of instruction/commands is 10 bits to 14 bits long.

At packet count 8 for PSDI signal 306 (e.g. after the last phase of data is sent), a stop key 332 is inserted. In the example embodiment of FIG. 3, the stop key 332 is a two-bit number (preferably, “00”). Parity bit(s) 334 are provided after the stop key 332. In some example embodiments, even parity per phase of instructions/commands is used. Final packet 336 is provided after stop key 332.

PSDO signals 308 and 310 represent communications from the motor drivers (e.g. motor drivers 116, 120, 124 and 128 of FIGS. 1 and 216, 220 and 224 of FIG. 2) to controller 102 of FIG. 1 or 202 of FIG. 2. In an example embodiment, the PSDO signals are an open-drain output in a wired-AND connection. Each motor driver remains in a “HIZ” state until it is addressed. This means that the device is in a high-impedance state (this non-driven state may appear as a constant logic high or logic low). PSDO signal 310 shows the “HIZ” response from each motor driver that was not addressed because that is the default state for each motor driver until it is addressed. Only the motor driver that was addressed (for example, motor driver 216 if the address “01” was provided at device address 314) receives the PSDI 306 signal and responds by the PSDO 308 signal. At packet count 1, PSDO signal 308 provides an “HIZ” status because the addressed motor driver has received its address, yet.

Starting at packet count 2, the addressed motor driver responds by providing its address 324 (which will be the same as the address provided at device address 314) followed by the status of the addressed motor driver. In an example embodiment, motor driver status 322 will be an x-bit error status feedback for the controller.

In packet counts 3 through 8 (for the example embodiment of FIG. 3), phase addresses (such as 318) and instruction/commands (such as 320, 346 and 348) received by the addressed motor driver (or previous instruction/commands) will be sent back to the controller at the phase addresses (such as 328) and instruction/commands (such as 330, 356 and 358) by the addressed motor driver.

At packet count 9, stop key 332 will be sent back to the controller at stop key 342 and parity 334 will be sent back to the controller at parity 344. After this point, the addressed motor driver returns to the “HIZ” state. The same process may be used to instruct/command another motor driver or the same motor driver.

Referring to the example embodiments of FIG. 4, timing diagram 400 shows example motor drive signals 402, 404 and 406 for motors “MTR1”, “MTR2” and “MTRn” where such motors may correspond to motors 240, 242 and 244 of FIG. 3, respectively. For example, motor drive signal 402 would be sent over signal lines 232, 234 and 236 to motor 240, motor drive signal 404 would be sent to motor 242 over the set of three-phase signal lines connected to motor 242 and motor drive signal 406 would be sent to motor 244 over the set of three-phase signal lines connected to motor 244. Even though only three motors (and motor drivers) are shown in FIG. 3, more motors (and motor drivers) than three can be used in other example embodiments. The use of more than three motors (and their corresponding motor drivers) is depicted in FIGS. 2 and 4 by the use of “n”. In some example embodiments, each PWM frame 414 includes instructions/commands for each of the “n” motors (via the corresponding motor driver). For example, PWM frame 414 includes three “sub-frames” 401, 403 and 405, where sub-frame 401 starts with a designator 350 (shown in FIGS. 3 and 4 as a “0”) to signify the start of the instructions for the first motor driver. After designator 350, sub-frame 401 will include, in some example embodiments, a data stream similar to PSDI signal 306 in FIG. 3. However, in some example embodiments, controller 202 may not have commands/instructions for a motor driver in a PWM frame 414 and some or all of the PSDI signal (such as PSDI signal 306) for that motor driver may be omitted or truncated. However, the other PSDI signals (such as PSDI signal 306) for the other motor drivers would not be omitted or truncated. For example, in a certain PWM frame 414, PSDI signals for motor driver 1 and motor driver n (shown as signals 401 and 405) may each look as shown as PSDI signal 306 because controller 202 is communicating instructions to motor driver 1 and motor driver n, but signal 403 remains at a certain state (HIZ state or a “0”) because controller 202 is not providing commands/instructions to motor driver 2.

While each PWM frame 414 may have different instructions/commands for PSDI signal 306, these differences will be reflected in each PWM frame 408, 416, 418 (for motor 1); 410, 420, 422 (for motor 2); and 412 and following (for motor n). PWM1 signal 408 corresponds to sub-frame 401, PWM2 signal 410 corresponds to sub-frame 403 and PWMn signal 412 corresponds to sub-frame 405. This cycle continues with the PWM1 signal 416 corresponding to PWM1 sub-frame of the second PWM frame 414, the PWM2 signal 420 corresponding to the PWM2 sub-frame of the second PWM frame 414, and so forth for each motor n (and motor driver n) (shown as PWMn). As discussed above with reference to omitted/truncated instructions/commands on PSDI signal 306 for a particular motor and motor driver, motor drive signals 402, 404 and 406 will reflect the omission or truncation of PSDI signal 306 for the respective motor/motor driver.

Certain terms have been used throughout this description and claims to refer to particular system components. As one skilled in the art will appreciate, different parties may refer to a component by different names. This document does not intend to distinguish between components that differ only in name but not in their respective functions or structures. In this disclosure and claims, the terms “including” and “comprising” are used in an open-ended fashion, and thus should be interpreted to mean “including, but not limited to . . . .”

The term “couple” is used throughout the specification. The term may cover connections, communications, or signal paths that enable a functional relationship consistent with the description of the present disclosure. For example, if device A generates a signal to control device B to perform an action, in a first example device A is coupled to device B by direct connection, or in a second example device A is coupled to device B through intervening component C if intervening component C does not alter the functional relationship between device A and device B such that device B is controlled by device A via the control signal generated by device A.

The above discussion is meant to be illustrative of the principles and various embodiments of the present invention. Numerous variations and modifications will become apparent to those skilled in the art once the above disclosure is fully appreciated.

What is claimed is:

1. A system for driving one or more motors, the system comprising:
a controller having an instruction output;
one or more motor drivers, each of the motor drivers are coupled to the instruction output of the controller and each of the motor drivers having a unique address; and
wherein each motor driver is only operable to receive instruction from the controller when its unique address is provided by the controller at the instruction output.

2. The system of claim 1, wherein each motor driver is coupled to a motor.

3. The system of claim 2, wherein each motor driver only drives one motor.

4. The system of claim 1, wherein the instruction output is a serial bus.

5. The system of claim 1, wherein the controller is a microcontroller, microprocessor, digital signal processor or field programmable gate array.

6. The system of claim 1, wherein the system is a camera gimbal, drone, robot or an automotive safety system.

7. The system of claim 1, wherein each motor is a three-phase motor.

8. A three-phase motor system comprising:
a controller;
a plurality of motor drivers, each having a distinct address, an input and a motor driver output;
a serial bus connecting the controller to each of the plurality of motor drivers;
a plurality of motors, each coupled to a motor driver; and
wherein each motor driver is operable to receive instructions from the controller only when the distinct address of the motor driver precedes the instructions on the serial bus.

9. The three-phase motor system of claim 8, wherein the controller is a microcontroller, microprocessor, digital signal processor or field programmable gate array.

10. The three-phase motor system of claim 8, wherein the three-phase motor system is used in a camera gimbal, drone, robot or an automotive safety system.

11. The three-phase motor system of claim 8, wherein the serial bus only includes a clocking connection and an instruction connection.

12. The three-phase motor system of claim 8, wherein the serial bus includes only includes a clocking connection, an instruction connection and a feedback connection.

13. A plurality of motor drivers each for driving a motor based on commands provided to each motor driver by a controller, wherein each motor is coupled to the controller by a serial bus having a clock wire and an instruction wire and each motor only acts upon instructions that are preceded by a unique address for the motor driver.

14. The plurality of motor drivers of claim 13, wherein each motor is a three-phase motor.

15. The plurality of motor drivers of claim 14, where each motor is a BLDC motor.
